(19) United States
(12) Patent Application Publication
(10) Pub. No.: US 2025/0392852 A1
(43) Pub. Date: Dec. 25, 2025

(54) EARRING-TYPE EARPHONE

(71) Applicant: Surprise Ant (Shenzhen) Internet Technology Co., Ltd., Shenzhen (CN)

(72) Inventors: Yuanhao LIU, Shenzhen (CN); Jiming Liu, Shenzhen (CN)

(21) Appl. No.: 19/242,519

(22) Filed: Jun. 18, 2025

(30) Foreign Application Priority Data
Jun. 19, 2024 (CN) 202410793651.4
May 20, 2025 (CN) 202510646728.X

(51) Int. Cl. H04R 1/10

(52) U.S. Cl. CPC H04R 1/1066; H04R 1/1016; H04R 1/105; H04R 1/1075

(57) ABSTRACT

The present application provides an earring-type earphone, the earring-type earphone includes a first component, a second component, a connecting member, and an earring component worn on the user's ear. The first component, comprising a driving element communicatively connected to an external device. The driving element is used to receive an audio signal from an external device. The second component includes a sound-emitting portion for playing the audio signal. Both ends of the connecting member are fixedly connected to the first component and the second component respectively. The driving element is electrically connected to the sound-emitting portion through the connecting member. The driving element controls the audio signal and transmits the audio signal to the sound-emitting portion for audio playback. The earring component, the first component, and the second component are connected by the connecting member to function as an ear ornament.

### CROSS-REFERENCE TO RELATED APPLICATIONS

This application claims priority to Chinese Patent Application No. 202510646728.X, filed on May 20, 2025, and claims priority to Chinese Patent Application No. 202410793651.4, filed on Jun. 19, 2024. The contents of the aforementioned applications are incorporated herein by reference in their entirety.

### TECHNICAL FIELD

The present application relates to the technical field of wireless earphones, in particular to an earring-type earphone.

### BACKGROUND

In At present, earphones are widely used in daily life as audio receiving devices. Among them, ear clip headphones are favored by some users because they do not need to be put into the user's ears, but they are fixed in the ears through clamping force. When worn for a long time, they can easily cause discomfort in the users' ears, seriously affecting the user experience and wearing comfort.

In-ear earphones and semi-in-earring earphones are mainly fixed by inserting into the user's ear canal or fitting the user's ear canal mouth. During exercise, large head shaking or daily activities, headphones can easily fall off from the ears due to factors such as differences in the shape of the ear canal and external force collision. Once the headphones fall off, not only will the audio playback be interrupted, but the headphones may also be lost or damaged due to falling to a hard-to-find corner or being trampled, resulting in economic losses and inconvenience to users.

Therefore, there is an urgent need for an earphone technical solution capable of taking into account wearing comfort and stability in order to solve the above problems existing in existing earphones.

### SUMMARY

In one aspect, the present application provides an earring-type earphone. The earring-type earphone includes:
a first component, comprising a driving element communicatively connected to an external device, where the driving element is used to receive an audio signal from an external device;
a second component, comprising a sound-emitting portion for playing the audio signal;
a connecting member, with both ends fixedly connected to the first component and the second component respectively, where the driving element is electrically connected to the sound-emitting portion through the connecting member, and the driving element controls the audio signal and transmits the audio signal to the sound-emitting portion for audio playback; and
an earring component, worn on the user's ear, where the earring component, the first component, and the second component are connected by the connecting member to function as an ear ornament.

In some embodiments provided by the present application, the earring component includes an earring body, an ear pin, and an earring stopper. The earring body is fixedly connected to the first component and penetrated by the connecting member. The ear pin is fixedly connected to the earring component to pass through the user's ear hole. The earring stopper is detachably connected to a free end of the ear pin. The earring body is provided with a second through-hole for the connecting member to pass through.

In some embodiments provided by the present application, the first component includes a first housing and a second housing, the first housing and the second housing are fixedly connected to form a first accommodating space for housing the driving element, and the first housing and the second housing form a fixed mounting portion connected to the earring body.

In some embodiments provided by the present application, the first component further includes a fixing frame housed within the first accommodating space and secondarily nested inside the first housing; and the first housing is made of a non-metallic material, and/or the second housing is made of a metallic material.

In some embodiments provided by the present application, the fixed mounting portion includes a first protruding portion and a second protruding portion, the first protruding portion extends outward from an outer wall of the first housing toward a side of the earring body, the second protruding portion extends outward from an outer wall of the second housing toward a side of the earring body, the first protruding portion and the second protruding portion are oppositely arranged and form a first through-hole interconnected with the first accommodating space for the connecting member to pass through, and the first protruding portion and the second protruding portion are fixedly connected to the earring body.

In some embodiments provided by the present application, the earring body is provided with a mounting groove that is mounted and matched with the first protruding portion and the second protruding portion, and the first protruding portion and the second protruding portion are fixedly installed in the mounting groove to fixedly connect the first component to the earring body.

In some embodiments provided by the present application, the earring body includes a first step portion and a second step portion, the first step portion and the second step portion protrude from a bottom of the mounting groove; and the mounting groove comprises a first cavity and a second cavity, the first cavity is enclosed by the first step portion and a groove wall of the mounting groove, the second cavity is formed between a side wall of the second step portion away from the first step portion and a groove wall of the mounting groove, and the first cavity and the second cavity are interconnected; and the first protruding portion is clamped in the first cavity, and the second protruding portion is clamped in the second cavity.

In some embodiments provided by the present application, a protruding height of the first step portion protruding from the bottom of the mounting groove is lower than that of the second step portion protruding from the bottom of the mounting groove, and the protruding height of the first protruding portion is lower than that of the second protruding portion.

In some embodiments provided by the present application, the earring body includes a first side portion facing away from the second component, and the second through-hole penetrates from the bottom of the mounting groove to the first side portion; or

where the earring body includes a second side portion for fixedly connecting the ear pin, and the second through-hole penetrates from the bottom of the mounting groove to the second side portion.

In some embodiments provided by the present application, the second through-hole is formed at a junction of the first step portion and the second step portion, partially penetrates the first step portion, and partially penetrates the second step portion; or
where the second through-hole penetrates a side of the second step portion away from the first step portion.

In some embodiments provided by the present application, the earring body is provided with a wire-clamping groove on a side facing away from the first component for accommodating the connecting member, the wire-clamping groove is connected to the second through-hole, and the number of wire-clamping grooves is one or two.

In some embodiments provided by the present application, the earring body includes an abutment block protruding from the second side portion to abut against the user's ear, the abutment block is located between the earring body and the ear pin, and a side of the abutment block abutting against the user's ear and a surface of the first housing close to the user's ear jointly abut against the user's earlobe.

In some embodiments provided by the present application, the connecting member can be used as a drop earring chain, and the connecting member includes a connecting housing and a connecting wire penetrating the connecting housing and electrically connecting the driving element and the sound-emitting portion at both ends.

In some embodiments provided by the present application, the second component can press against the user's concha cavity when worn, the second component includes a third housing and a fourth housing connected to the third housing and press against the user's concha cavity, the third housing and the fourth housing form a second accommodating space for accommodating the sound-emitting portion, the third housing is provided with a plurality of sound outputting holes, and sound emitted by the sound-emitting portion is transmitted into the user's ear through the sound outputting holes.

In some embodiments provided by the present application, the driving component includes a circuit board provided with a driving control module, a power supply component electrically connected to the driving control module, an antenna electrically connected to the driving control module to transmit and receive signals, a charging interface electrically connected to the circuit board, and a magnetic member magnetically matched with a metal block in a charging compartment to make the charging interface contact with the metal block in the charging compartment. The antenna and the magnetic member are fixed to a fixed bracket, and the power supply component is accommodated in an accommodating space of the fixed bracket.

In a second aspect, the present application provides an earring-type earphone. The earring-type earphone includes:
a functional component;
a second component; and
an earring component, wherein the second component is connected to the functional component, the earring component cooperates with the functional component, and the earring component is used to pass through the user's ear hole and is fixed onto the user's earlobe.

In some embodiments provided by the present application, when the earring-type earphone is in an earphone form, the second component is used to fit into the user's concha cavity to transmit sound; and when the earring-type earphone is in a decorative form, the second component is removed from the user's concha cavity and hangs downward to function as an ear ornament.

In some embodiments provided by the present application, the functional component includes a first component and a connecting member, and the first component and the second component are connected to both ends of the connecting member.

In some embodiments provided by the present application, the earring component includes an earring body and an earring stopper; the earring body is inserted into the user's ear hole, and the earring stopper is fixed to the earring body when worn and is located on both sides of the user's ear hole; and the earring body, the first component, and the second component are connected via the connecting member to function as an ear ornament.

In some embodiments provided by the present application, the earring body and the first component are cooperatively arranged, and the earring stopper is detachably connected to the earring body; or
where the earring body and the connecting member are cooperatively arranged, and the earring stopper is detachably connected to the earring body.

In some embodiments provided by the present application, the material of the earring component is at least one of copper, silver, stainless steel, precious metal, ABS material, PP material, PC material, rubber, and silicone material.

In some embodiments provided by the present application, the second component includes a sound-emitting portion, a third housing, and a fourth housing, the third housing and the fourth housing form a second accommodating space, the sound-emitting portion, the third housing and the fourth housing are connected to each other, and the sound-emitting portion is accommodated in the second accommodating space.

In some embodiments provided by the present application, the second component further includes a sound-emitting portion, and the sound-emitting portion is installed in the second accommodating space.

In some embodiments provided by the present application, the first component includes a first housing and a second housing, and the first housing and the second housing are connected to each other to form a first accommodating space.

In some embodiments provided by the present application, the first component further includes a drive module, and the drive module is installed in the first accommodating space.

In a third aspect, the present application provides an earring-type earphone. The earring-type earphone includes:
a first component;
a second component;
a connecting member, connected between the first component and the second component; and
an earring component, worn on the user's ear;
where when the earring-type earphone is in an earphone form, the second component is worn in the user's concha cavity to play audio; and/or, when the earring-type earphone is in an ear ornament form, the earring component, the first component, and the second component are connected via the connecting member to function as an ear ornament.

The earring-type earphone provided by the embodiments of the present application uses the connecting member to connect the first component and the second component, so that the driving element transmits the audio signal received from the external device through the sound-emitting portion, realizes earring-type earphone function of playing and listening the audio signal, and prevents the second component from being easily lost when the audio is not playing and the second component 20 is removed, and can also be used as an earring-type ornament. At the same time, the earring-type earphone is worn on the user's ear by using the earring component, so that the earring component, the first component, and the second component can be used as an earring by connecting by the connecting member. On the one hand, using the earring-type earphone as an earring greatly improves the aesthetic degree of the earring-type earphone, on the other hand, the stability of the second component can be ensured even if the second component is not worn in the concha cavity of the user, and the problem of loss or drop is not easy to occur.

### BRIEF DESCRIPTION OF THE DRAWINGS

In order to more clearly explain the technical solutions in the embodiments of the present application, the accompanying drawings that need to be used in the description of the embodiments will be briefly introduced below, and it is obvious that the accompanying drawings in the following description are only some embodiments of the present application, and for those skilled in the art, other accompanying drawings can be obtained from these accompanying drawings without making creative labor.

FIG. 1 is a schematic diagram of wearing an earring-type earphone according to embodiments of the present application.

FIG. 2 is a schematic diagram of a first state structure of an earring-type earphone according to a first preferred embodiment of the present application.

FIG. 3 is a schematic diagram of a second state structure of an earring-type earphone according to a first preferred embodiment of the present application.

FIG. 4 is a schematic diagram of a structure of an earring body of the earring-type earphone according to the first preferred embodiment of the present application in one direction.

FIG. 5 is a schematic diagram of a structure of the earring body of the earring-type earphone according to the first preferred embodiment of the present application in another direction.

FIG. 6 is a schematic cross-sectional structural diagram of the earring-type earphone according to a first preferred embodiment of the present application.

FIG. 7 is a schematic diagram of an exploded structure in one direction of the earring-type earphone according to the first preferred embodiment of the present application.

FIG. 8 is a schematic diagram of an exploded structure of the earring-type earphone according to a first preferred embodiment of the present application in another direction.

FIG. 9 is a schematic diagram of a first state structure of an earring-type earphone according to a second preferred embodiment of the present application.

FIG. 10 is a schematic diagram of a second state structure of the earring-type earphone according to the second preferred embodiment of the present application.

FIG. 11 is a schematic diagram of a structure of an earring body of the earring-type earphone according to the second preferred embodiment of the present application in one direction.

FIG. 12 is a schematic diagram of the structure of the earring body of the earring-type earphone according to the second preferred embodiment of the present application in another direction.

FIG. 13 is a schematic cross-sectional structural diagram of the earring-type earphone according to the second preferred embodiment of the present application.

FIG. 14 is a schematic diagram of a structure of an earring-type earphone according to a third preferred embodiment of the present application in one direction.

FIG. 15 is a schematic diagram of the structure of the earring-type earphone according to the third preferred embodiment of the present application in another direction.

FIG. 16 is a schematic cross-sectional structural diagram of the earring-type earphone according to the third preferred embodiment of the present application.

FIG. 17 is a schematic diagram of the earring-type earphone according to the third preferred embodiment of the present application in an ear ornament form.

FIG. 18 is a schematic diagram of an earring-type earphone according to the third preferred embodiment of the present application in an ear ornament form.

FIG. 19 is another schematic diagram of the earring-type earphone according to the third preferred embodiment of the present application in the ear ornament form.

FIG. 20 is a schematic diagram of a structure of an earring-type earphone according to a fourth preferred embodiment of the present application in one direction.

FIG. 21 is a schematic diagram of the structure of the earring-type earphone according to the fourth preferred embodiment of the present application in another direction.

FIG. 22 is a schematic cross-sectional structural diagram of the earring-type earphone according to the fourth preferred embodiment of the present application.

FIG. 23 is a schematic diagram of the earring-type earphone according to the fourth preferred embodiment of the present application in an ear ornament form.

FIG. 24 is a schematic diagram of an earring-type earphone according to the fourth preferred embodiment of the present application in an ear ornament form.

FIG. 25 is another schematic diagram of the earring-type earphone according to the fourth preferred embodiment of the present application in the ear ornament form.

### MAIN REFERENCE NUMBERS

| Serial | | Serial | |
|---|---|---|---|
| number | Feature Name | number | Feature Name |
| 10 | first component | 20 | second component |
| 12 | driving element | 22 | sound-emitting portion |
| 121 | circuit board | 23 | sound outputting hole |
| 123 | contact terminal | 24 | third housing |
| 124 | fixed bracket | 26 | fourth housing |
| 125 | power supply | 28 | second accommodating |
| | component | | space |
| 126 | magnetic member | 40 | earring component |
| 127 | antenna | 42 | earring body |
| 13 | first housing | 421 | mounting groove |
| 130 | first protruding portion | 4210 | first cavity |
| 14 | second housing | 4212 | second cavity |
| 140 | second protruding | 422 | first step portion |
| | portion | | |
| 15 | first accommodating | 424 | second step portion |
| | space | | |
| 16 | fixed mounting portion | 425 | second through-hole |
| 17 | first through-hole | 426 | first side portion |
| 18 | fixing frame | 427 | second side portion |
| 30 | connecting member | 428 | wire-clamping groove |
| 32 | connecting housing | 429 | abutment block |
| 34 | connecting wire | 44 | ear pin |
| | | 46 | earring stopper |

### DETAILED DESCRIPTION OF EMBODIMENTS

Hereinafter, the technical solutions in the embodiments of the present application will be clearly and completely described with reference to the accompanying drawings in the embodiments of the present application, and it is obvious that the described embodiments are only a part of the embodiments of the present application, but not all the embodiments. Accordingly, it will be apparent to those skilled in the art that the following description of various embodiments of the present application is provided for the purpose of illustration only and not for the purpose of limiting the application as defined by the appended claims and their equivalents. Based on the embodiments in the present application, all other embodiments obtained by those skilled in the art without creative work belong to the scope of protection of the present application.

It is to be understood that the term “a” should be understood as “at least one” or “one or more”, i.e., in one embodiment, the number of elements may be one, while in further embodiments, the number of elements may be multiple, and the term “a” should not be understood as a limitation of the number.

Although ordinal numbers such as “first”, “second”, etc. will be used to describe various components, those components are not limited herein. The term is only used to distinguish one component from another. For example, a first component may be referred to as a second component, and likewise, a second component may also be referred to as a first component without departing from the teachings of the present concept. The term “and/or” as used herein includes any and all combinations of one or more associated listed items.

The terminology used herein is for the purpose of describing various embodiments only and is not intended to be limiting. As used herein, the singular form is intended to include the plural form as well, unless the context clearly dictates an exception. It is also to be understood that the terms “comprising” and/or “having” when used in this specification specify the presence of a stated feature, number, step, operation, component, element, or combination thereof, without precluding the presence or addition of one or more other features, numbers, steps, operations, component, element, or combination thereof.

Hereinafter, each of them will be described in detail. Note that the order of description of the following embodiments is not intended to limit the preferred order of the embodiments.

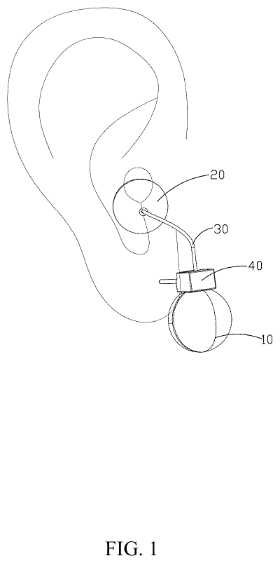

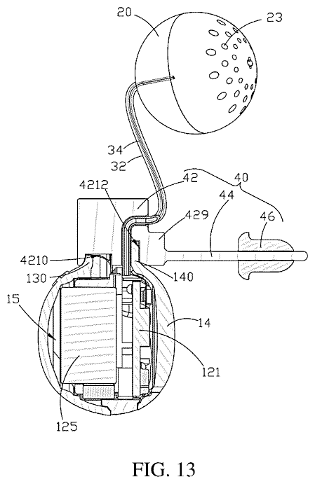

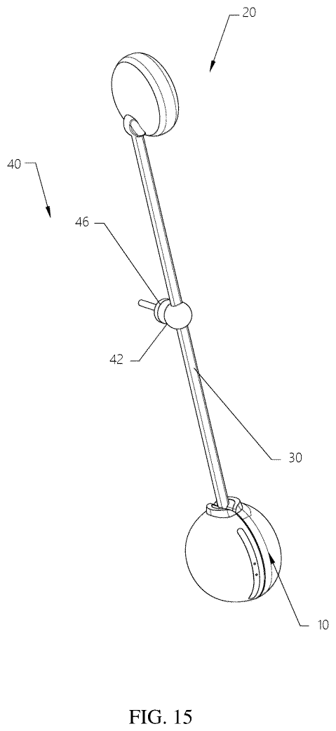

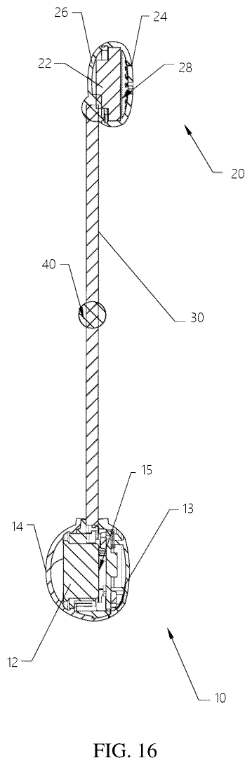

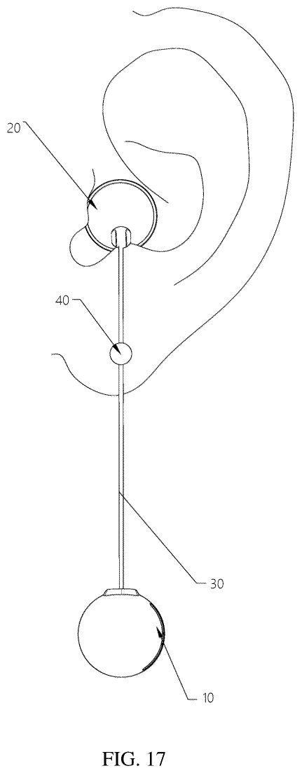

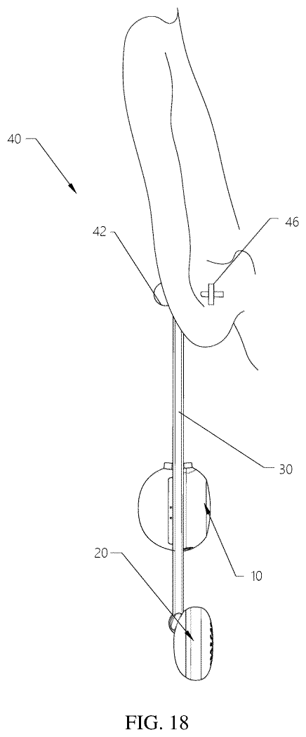

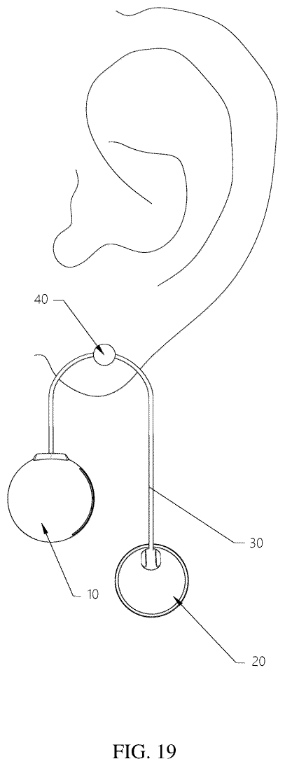

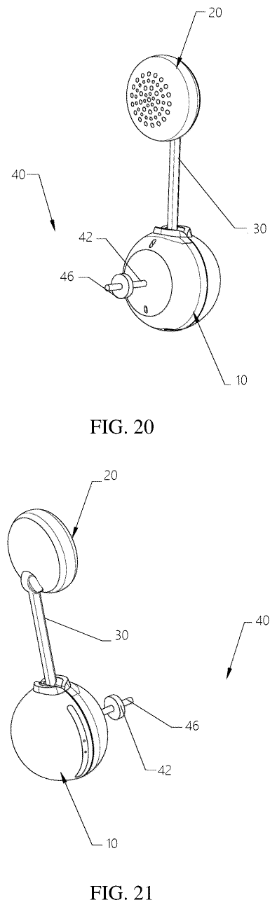

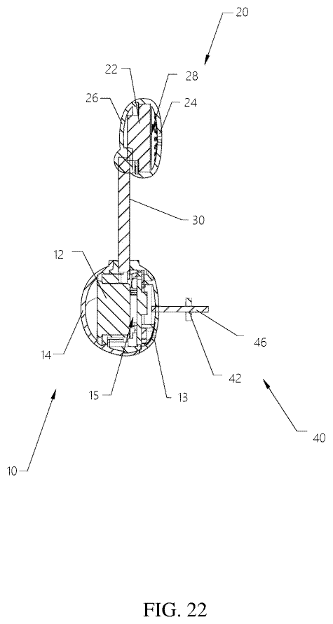

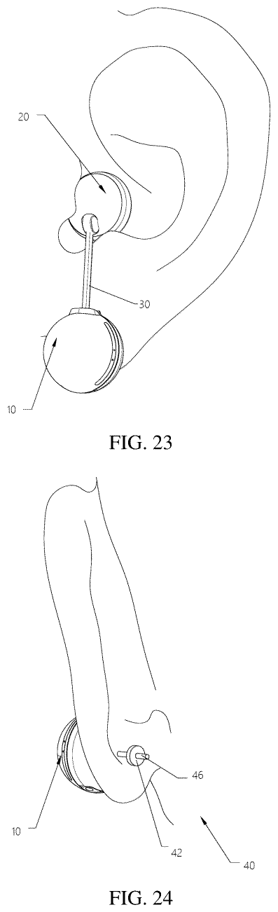

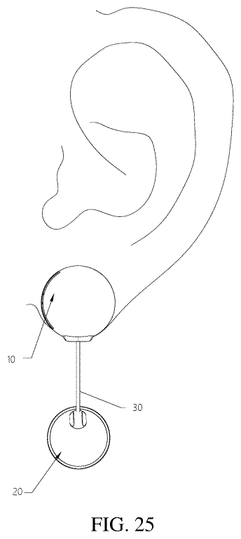

Referring to FIGS. 1 to 25, in one aspect, an earring-type earphone is provided by the present application, the earring-type earphone includes:
a first component 10, including a driving element 12 communicatively connected to an external device (not shown), the driving element 12 receiving an audio signal from an external device;
a second component 20, including a sound-emitting portion 22 for playing the audio signal;
a connecting member 30, with both ends fixedly connected to the first component 10 and the second component 20 respectively, where the driving element 12 is electrically connected to the sound-emitting portion 22 through the connecting member 30, and the driving element 12 controls the audio signal and transmits the audio signal to the sound-emitting portion 22 for audio playback; and
an earring component 40, worn on the user's ear, where the earring component 40, the first component 10, and the second component 20 are connected by the connecting member 30 to function as an ear ornament.

The earring-type earphone provided by the embodiment of the present application connects the first component 10 and the second component 20 by the connecting member 30, so that the driving element 12 transmits the audio signal received from the external device through the sound-emitting portion 22, realizes earring-type earphone function of playing and listening the audio signal, and prevents the second component 20 from being easily lost when the audio is not playing and the second component 20 is removed, and can also be used as an earring-type ornament. At the same time, the earring-type earphone is worn on the user's ear by using the earring component 40, so that the earring component 40, the first component 10, and the second component 20 can be used as an earring by connecting the connecting member 30. On the one hand, using earring-type earphone as an earring greatly improves the aesthetic appearance of earring-type earphone, and on the other hand, the second component 20 can ensure the stability of the second component 20 even if the second component 20 is not worn in the ear concha cavity of the user, and it is not easy to be lost or fallen.

In this embodiment, the sound-emitting portion 22 is arranged in the second component 20, and the driving element 12 is arranged in the first component 10, so that the sound-emitting portion 22 and the driving element 12 are arranged separately, and enough space can be ensured to install the sound-emitting portion 22 and the driving element 12, so as to ensure the sound quality of earring-type earphone, for example, it has the advantages of good low-frequency sound quality and low sound pressure. When wearing the earring-type earphone, the second component 20 presses against the user's concha cavity, and the first component 10 is arranged at the other end of the connecting member 30 to ensure the stability of wearing earring-type earphone and enhance the functionality and decoration of earring-type earphone. For example, various ornaments can be designed and configured on the first component 10, the second component 20, and the connecting member 30 to make the earring-type earphone become a component of the user's accessories such as earrings, ear hoops, ear clips, etc., It can also enhance the comfort of the earphone wearing, and is less likely to cause ear pain, swelling, and noise.

In this embodiment, outer shapes of the first component 10 and the second component 20 may be designed such as spherical, spherical, ellipsoid or any other shape, and it is preferable that the outer shapes of the first component 10 and the second component 20 can play a decorative role.

In some embodiments provided by the present application, the earring component 40 includes an earring body 42, an ear pin 44, and an earring stopper 46. The earring body 42 is fixedly connected to the first component 10 and penetrated by the connecting member 30. The ear pin 44 is fixedly connected to the earring component 40 to pass through the user's ear hole. The earring stopper 46 is detachably connected to a free end of the ear pin 44. The earring body 42 is provided with a second through-hole 425 for the connecting member to pass through.

Referring to FIGS. 1 to 25, in some embodiments provided by the present application, the first component 10 includes a first housing 13 and a second housing 14. The first housing 13 and the second housing 14 are fixedly connected to the second housing 14 and form a first accommodating space 15 for accommodating the driving element 12. The first housing 13 and the second housing 14 form a fixed mounting portion (not marked) fixedly connected to the earring body 42. The earring body 42 is fixedly connected to the fixed mounting portion 16 to fixedly connect the earring component 40 and the first component 10. when the earring-type earphone is worn, the first component 10 is worn as an earring near the user's earlobe as an earring ornament, and the second component 20 is positioned at the other end of the connecting member 30, and can be worn in the concha cavity of the user, or can be taken out from the concha cavity as an earring ornament, and can be used as an earring ornament.

Referring to FIGS. 6 to 10 and 13, it can be understood that the first housing 13 and the second housing 14 constitute an outer structure of the first component 10. The first housing 13 may be made of a metallic material or a non-metallic material. An outer surface of the first housing 13 may be sprayed with materials of different colors and glossiness, such as gold, silver or gradient color. When the first housing 13 is made of a metal material, jewelry ornaments such as precious stones and diamonds may be inlaid on the outer surface of the first housing 13 to enhance the aesthetic appearance of the first component 10. The second housing 14 is made of a non-metallic material. An outer surface of the second housing 14 can be sprayed with materials of different colors and glossiness, such as gold, silver, or gradient color.

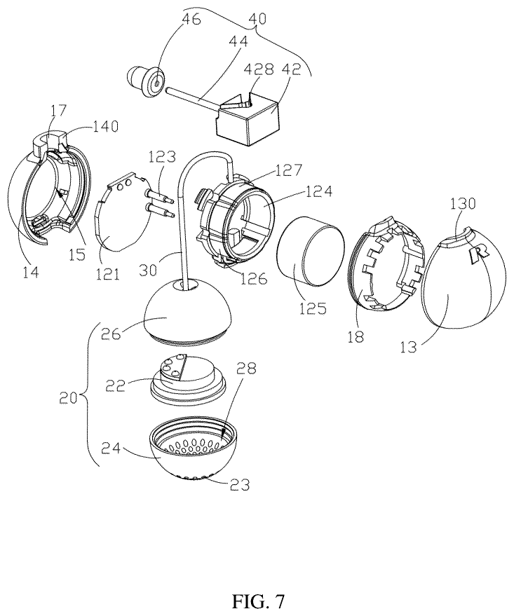

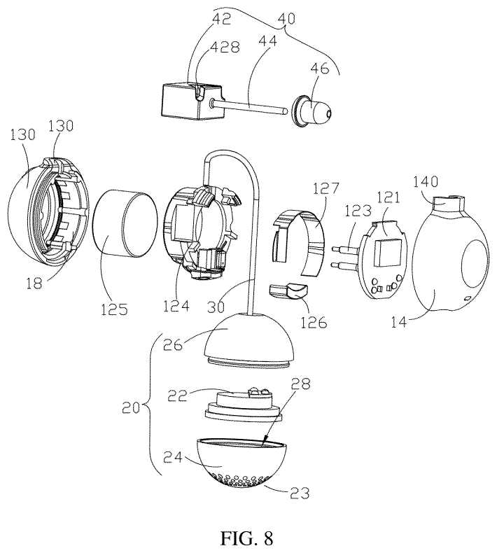

Referring to FIGS. 7 and 8, in some embodiments provided by the present application, the first component 10 further includes a fixing frame 18 housed within the first accommodating space 15 and secondarily nested inside an inner side of the first housing 13. The first housing 13 is made of a non-metallic material, and/or the second housing 14 is made of a metallic material.

Referring to FIGS. 6 to 8 and 13, in some embodiments provided by the present application, the fixed mounting portion includes a first protruding portion 130 protruding along an outer wall of the first housing 13 toward a side of the earring body 42 and a second protruding portion 140 protruding along the outer wall of the second housing 14 toward the side of the earring body 42. The first protruding portion 130 and the second protruding portion 140 are oppositely arranged and form a first through-hole 17 interconnected with the first accommodating space 15 for the connecting member 30 to pass through. The first protruding portion 130 and the second protruding portion 140 are fixedly connected to the earring body 42. To ensure that the earring component 40 is mounted securely and reliably with the first component 10, the first protruding portion 130 is provided on the first housing 13 and the second protruding portion 140 is provided on the second housing 14, and the first protruding portion 130 and the second projection 140 are fixedly connected to the earring body 42.

In this embodiment, the first protruding portion 130 and the first housing 13 are integrally molded, and the second protruding portion 140 and the second housing 14 are integrally molded.

In other embodiments, the first protruding portion 130 and the second protruding portion 140 may be provided on the first housing 13 or the second housing 14 at the same time.

Referring to FIGS. 4 to 13, in some embodiments provided by the present application, the earring body 42 is provided with a mounting groove 421 that is mounted and matched with the first protruding portion 130 and the second protruding portion 140. The first protruding portion 130 and the second protruding portion 140 are fixedly mounted in the mounting groove 421 to fixedly connect the first component 10 and the earring body 42. By providing the mounting groove 421, the first protruding portion 130 and the second protruding portion 140 are fixedly mounted in the mounting groove 421, so that the first component 10 and the earring body 42 are fixedly connected.

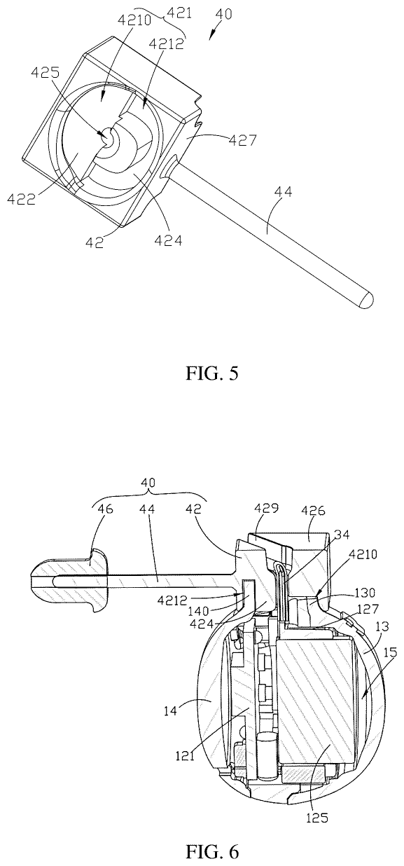

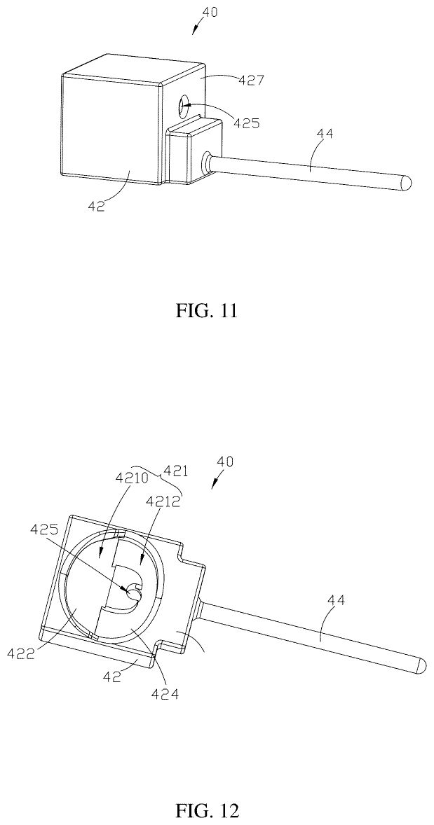

Referring to FIG. 4, FIG. 5, FIG. 11, and FIG. 12, in some embodiments provided by the present application, the earring body 42 includes a first step portion 422 and a second step portion 424 protruding along a bottom of the mounting groove 421. The mounting groove 421 includes a first cavity 4210 and a second cavity 4212. The first cavity 4210 enclosed by the first step portion 422 and a groove wall of the mounting groove 421. The second cavity 4212 is formed by a side wall of the second step portion 424 away from the first step portion 422 and the groove wall of the mounting groove 421. The first cavity 4210 and the second cavity 4212 are interconnected. The first protruding portion 130 is locked in the first cavity 4210. The second protruding portion 140 is locked in the second cavity 4212. At the time of attachment, the earring body 42 is fixedly connected to the first housing 13 and the second housing 14 by engaging the first protruding portion 130 of the first housing 13 in the first cavity 4210 and engaging the second protruding portion 140 of the second housing 14 in the second cavity 4212.

Referring to FIG. 4, FIG. 5, FIG. 11, and FIG. 12, in some embodiments provided by the present application, a protruding height of the first step portion 422 protruding from the bottom of the mounting groove 421 is lower than that of the second step portion 424 protruding from the bottom of the mounting groove 421. The protruding height of the first protruding portion 130 is lower than that of the second protruding portion 140. Alternatively, the protruding height of the first step portion 422 protruding from the bottom of the mounting groove 421 is higher than that of the second step portion 424 protruding from the bottom of the mounting groove 421. The protruding height of the first protruding portion 130 is higher than that of the second protruding portion 140.

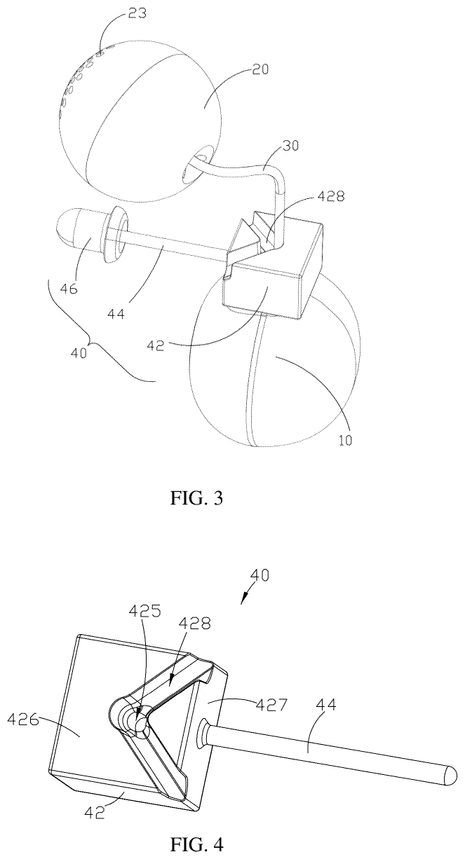

Referring to FIGS. 3 to 13, in some embodiments provided by the present application, the earring body 42 is provided with a second through-hole 425 connected to with mounting groove 421 for the connecting member 30 to pass through.

The earring body 42 has a first side portion 426, the first side portion 426 faces away from the second component 20, and the second through-hole 425 penetrates the bottom of the mounting groove 421 to the first side portion 426. Alternatively, the earring body 42 has a second side portion 427 for fixedly connecting the ear pin 44, and the second through-hole 425 penetrates the groove bottom of the mounting groove 421 to the second side portion 427.

Referring to FIGS. 4 to 12, in some embodiments provided by the present application, the second through-hole 425 is formed at a junction of the first step portion 422 and the second step portion 424, partially penetrates the first step portion 422, and partially penetrates the second step portion 424. Alternatively, the second through-hole 425 penetrates a side of the second step portion 424 facing away from the first step portion 422.

In some embodiments provided by the present application, the earring body 42 is provided with a wire-clamping groove 428 on a side facing away from the first component 10 for accommodating the connecting member 30. The wire-clamping groove 428 is connected to the second through-hole 425. The number of the wire-clamping groove 428 is one or two. When the number of slots 428 is two, the connecting member 30 can be guided in different directions to position the second component 20 in front or behind the first component 10.

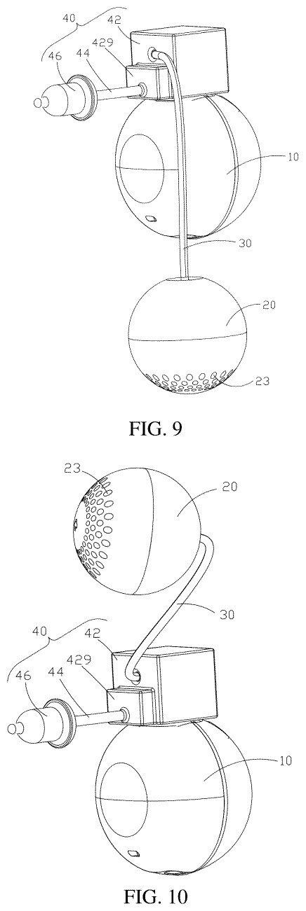

Referring to FIGS. 9 to 13, in some embodiments provided by the present application, the earring body 42 includes an abutment block 429 protruding from the second side portion 427 to abut against the user's ear. The abutment block 429 is located between the earring body 42 and the car pin 44. A side of the abutment block 429 abutting against the user's ear and a surface of the first housing 13 close to the user's ear jointly abut against the user's earlobe. The earring body 42 is provided with the abutment block 429 so as to abut against the user's ear when worn, so as to substantially abut against the user's ear flush with the first component 10 and prevent wearing tilt. Referring to FIGS. 1 to 13, in some embodiments provided in the present application, the connecting member 30 can be used as a drop earring chain, and the connecting member 30 includes a connecting housing 32 and a connecting wire 34 that penetrates the connecting housing 32 and electrically connects the driving element 12 and the sound-emitting portion 22 at both ends. The connecting housing 32 is made of a non-metallic insulating material, and an outer surface thereof may be sprayed with different colors and gloss, such as gold, silver, gradient, etc.

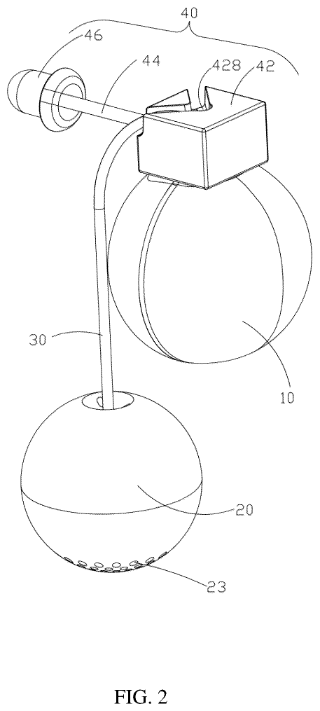

Referring to FIGS. 2 to 13, 16, and 22, in some embodiments provided by the present application, the second component 20 can press against the user's concha cavity when worn. The second component 20 includes a third housing 24 and a fourth housing 26 connected to the third housing 24 and press against the user's concha cavity. The third housing 24 and the fourth housing 26 form a second accommodating space 28 for accommodating the sound-emitting portion 22. The third housing 24 is provided with a plurality of sound outputting holes 23. The sound emitted by the sound-emitting portion 22 is transmitted into the user's ear through the sound outputting holes 23. The second component 20 is formed by the third housing 24 and the fourth housing 26 to form a second accommodating space 28 for accommodating and installing the sound-emitting portion 22, and the sound-emitting portion 22 converts the received audio signal into sound waves and transmits the received audio signal to the user to provide the user with an audio experience.

In this embodiment, the third housing 24 and the fourth housing 26 constitute an outer structure of the first component 10. The third housing 24 may be made of a non-metallic material, and an outer surface of the third housing 24 may be sprayed with materials of different colors and glossiness, such as gold, silver or gradient color to enhance the aesthetics of the first component 10. The fourth housing 26 is made of a metal material or a non-metal material. An outer surface of the fourth housing 26 may be sprayed with materials of different colors and glossiness, for example, gold, silver, or gradual color. When the outer surface of the fourth housing 26 is made of a metal material, jewelry ornaments such as precious stones and diamonds may be inlaid on the outer surface of the fourth housing 26.

Referring to FIGS. 6 to 8 and 13, in some embodiments provided by the present application, the driving element 12 includes a circuit board 121 provided with a drive control module, a power supply component 125 electrically connected to the drive control module, an antenna 127 electrically connected to the drive control module to transmit and receive signals, a charging interface (unshown) electrically connected to the circuit board 121, and a magnetic member 126 magnetically matched with a metal block in a charging compartment to make the charging interface contact with the metal block in the charging compartment. The antenna 127 and the magnetic member 126 are fixed to a fixed bracket 124, and the power supply component 125 is accommodated in an accommodating space (unlabeled) of the fixed bracket 124.

In this embodiment, a microphone module, an audio conversion module, a communication module, a charging module, a voice interaction module, and the like are built into the drive control module. Preferably, the microphone module is used for collecting the voice of the user, converting a voice signal into an electrical signal through the audio conversion module, and transmitting the voice signal to an audio output module through the communication module, so as to realize the function of voice communication or voice command input. The communication module may adopt a wireless Bluetooth connection, a WI-FI wireless connection, or an NFC wireless pairing, that is, the first component 10 realizes a communication connection with an external audio device through the wireless Bluetooth connection, the WI-FI wireless connection, or the NFC wireless pairing. The charging module is configured to connect a charging device to charge the power supply component 125, and an interface adopted by the charging module may be a USB-C interface, a Micro-USB interface, or the like. The voice interaction module mainly includes a language wake-up unit which adopts an acoustic form and a pattern matching algorithm to trigger the monitored wake-up word to trigger earring-type earphone into a working state, a voice recognition unit which adopts a voice recognition algorithm to convert the voice command output by the user into a digital signal, a voice synthesis unit which adopts a text-to-voice form to convert the text signal into a voice signal, and a voice control unit which is used for coordinating and controlling the work of each part of the voice interaction module. At the same time, the voice control unit will also interact with the power management module of the headset, communication modules such as Bluetooth, etc., to realize the overall management and optimization of the working status of the headset.

In each embodiment of the present application, the power supply component 125 provides power support for each functional module of the earring-type earphone, and preferably, the power supply component 125 adopts a built-in lithium battery and has a rechargeable function. When it is needed, the power supply component 125 may be charged by connecting the drive control module to an external power supply to ensure normal use of earring-type earphone.

In this embodiment, the fixed bracket 124 assembles the power supply component 125, the antenna 127, and the magnetic member 126 into one assembly, which is simple in structure and easy to install and transport. The antenna 127 and the magnetic member 126 are fixedly mounted on an outer side wall of the fixed bracket 124 facing away from the accommodating space, and the antenna 127 is electrically connected to the control module on the circuit board 121 through a contact terminal 123 provided on the circuit board 121.

Referring to FIGS. 1 to 25, in a second aspect, the present application provides an earring-type earphone, the earring-type earphone including:
a functional component (unlabeled);
a second component 20; and
an earring component 40, where the second component 20 is connected to the functional component, the earring component 40 cooperates with the functional component, the earring component 40 is used to pass through the user's ear hole and is fixed onto the user's earlobe.

In the present embodiment, the earring-type earphone includes the second component 20, the functional component, and the earring component 40, the second component 20 is connected to the functional component, specifically, the second component 20 is connected to a front end of the functional component, the earring component 40 cooperates with the functional component, and the earring component 40 is used to pass through the ear hole of the user and is fixed onto the user's earlobe.

In some embodiments provided by the present application, when the earring-type earphone is in an earphone form, the second component 20 is used to fit into the user's concha cavity to transmit sound. When the earring-type earphone is in a decorative form, the second component 20 is removed from the user's concha cavity and hangs downward to function as an ear ornament. In this way, the earring-type earphone can not only achieve the sound effect transmission function of earphones, but also be used as earring ornaments.

Referring to FIGS. 2 to 13, 16, and 22, in this embodiment, the second component 20 includes a sound-emitting portion 22, a third housing 24, and a fourth housing 26. The sound-emitting portion 22, the third housing 24, and the fourth housing 26 are connected to each other. The third housing 24 and the fourth housing 26 form a second accommodating space 28. The sound-emitting portion 22 is accommodated in the second accommodating space 28.

In this embodiment, the sound-emitting portion 22 is housed in the second accommodating space 28. The sound-emitting portion 22 is used to provide sound effect output for various loudspeakers capable of emitting sound effects. Compared with the traditional earphone, the sound-emitting portion 22 of the earring-type earphone is placed in the user's ear canal, which is easy to cause damage to the user's hearing. In this embodiment, the second component 20 is adapted to be fitted to the user's concha cavity to transmit sound effects, and does not cause damage to the user's hearing without affecting the sound production. In addition, surfaces of the third housing 24 and the fourth housing 26 also have at least one noise reduction hole, the noise reduction hole extends inwardly from the surfaces of the third housing 24 and the fourth housing 26 to penetrate the third housing 24 and the fourth housing 26, and the noise reduction hole communicates with the second accommodating space 28 to the outside, so as to avoid air pressure instability due to vibration of the second accommodating space 28 and provide a physical noise reduction effect.

In some embodiments provided by the present application, the functional component includes a first component 10 and a connecting member 30, and the first component 10 and the second component 20 are connected to both ends of the connecting member 30.

Referring to FIGS. 2 to 13, 16, and 22, in this embodiment, the first component 10 includes a first housing 13 and a second housing 14. The first housing 13 and the second housing 14 are connected to each other to form the first accommodating space 15. Both ends of the connecting member 30 are respectively connected to the driving element 12 of the first housing 13 and the sound-emitting portion 22 of the second component 20. The driving element 12 is integrated with a power supply, a control button, and a circuit board to control the sound effect transmission of the earring-type earphone.

In this embodiment, patterns, diamonds, textures, etc. may be provided on surfaces of the third housing 24 of the second component 20 and the first housing 13 of the first component 10 to increase the fashion of the earring-type earphones, and may be set according to the needs of users to meet the aesthetics of different users.

Referring to FIGS. 1 to 25, in some embodiments provided by the present application, the earring component 40 includes an earring body 42 and an earring stopper 46. The earring body 42 is used to be inserted into the user's ear hole. The earring stopper 46 is fixed to the earring body 42 when worn and is located on both sides of the user's ear hole with the earring body 42. The earring body 42, the first component 10, and the second component 20 can be used as an earring by connecting the connecting member 30.

In an embodiment of the present application, the earring component 40 and the first component 10 cooperate with each other, and the earring component 40 can be passed through an ear hole and fixed at the user's earlobe, thereby fixing the earring-type earphone to the user's ear. In other embodiments, the earring component 40 may also be disposed on the connecting member 30, and it will be understood by those skilled in the art that the location of the earring component 40 is not a limitation of the present application.

In this embodiment, the earring body 42 is sleeved outside the first component 10. In other embodiments, the earring body 42 can protrude and extend outward from the first component 10 to be inserted into the user's ear hole and fixed at the user's earlobe, which is not limited by the present application. The earring stopper 46 is detachably provided on the earring body 42.

Referring to FIGS. 1 to 25, in some embodiments provided by the present application, the earring body 42 and the first component 10 are arranged in cooperation with each other, and the earring stopper 46 is detachably connected to the earring body 42. Alternatively, the earring body 42 and the connecting member 30 are arranged in cooperation with each other, and the earring stopper 46 is detachably connected to the earring body 42.

In this embodiment, when the earring-type earphone is worn, the earring stopper 46 is first removed, the earring body 42 is inserted into the user's ear hole and fixed to the user's earlobe, and then the earring stopper 46 is installed on the earring body 42 to prevent the earring-type earphone slipping from the user's ears and improving the stability of the earring-type earphones.

In some embodiments provided in the present application, the material of the earring component 40 is at least one of copper, silver, stainless steel, precious metal, ABS, PP, PC, rubber, and silicone. The shape, the color, the material, etc. of the earring component 40 can be set and replaced according to the user's needs, which greatly improves the fashion and diversity of the earring-type earphone, and enables the earring-type earphone to meet aesthetic needs of different users.

In other embodiments, the earring body 42 of the earring component 40 may be red and made of stainless steel, and the earring stopper 46 is arranged to be annularly sleeved over the earring body 42. In another embodiment, the earring body 42 of the earring component 40 is made of silver and made of a titanium alloy material, and the earring stopper 46 is provided in a wreath shape and sleeved over the earring body 42. In another embodiment, the earring body 42 of the earring component 40 is provided in gold and made of plastic material, and the earring stopper 46 is provided in a triangular annular shape and sleeved on the earring body 42, which is not limited by the present application.

In this embodiment, the earring-type earphones are stably fixed to the user's earlobe by the earring component 40, and do not fall even during strenuous exercise, thereby ensuring the stability of the earring-type earphones. Further, since the earring component 40 is stably fixed to the user's earlobe, a pressure on the user's ear by the earring-type earphone can be minimized, the pressure on the ear by wearing the earring-type earphone for a long time can be reduced, and a more comfortable enjoyment experience can be brought to the user.

In this embodiment, when the earring-type earphone is in an earphone form, the second component 20 is adapted to fit into the user's concha cavity of the user to transmit sound effects. When the earring-type earphone is in an ear ornament form, the second component 20 is taken out and dropped downward as an earring, so as to meet the demand of the earring-type earphone as an ornament. The earring-type earphone combines earphones with earrings, satisfies the dual demand of the user for fashion and function, and can minimize the pressure of the earring-type earphone on the user's ears and ensure the stability of the earring-type earphone.

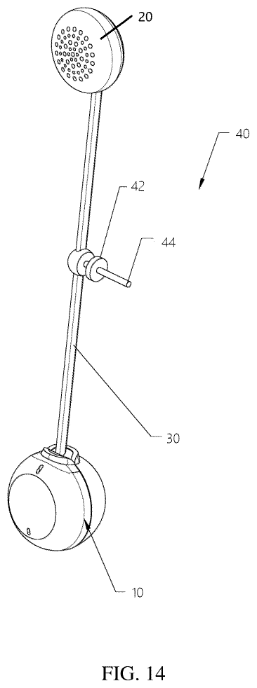

Referring to FIGS. 14 to 25, in some embodiments provided by the present application, the second component 20 includes a sound-emitting portion 22, a third housing 24, and a fourth housing 26. The third housing 24 and the fourth housing 26 form a second accommodating space 28. The sound-emitting portion 22, the third housing 24, and the fourth housing 26 are connected to each other. The sound-emitting portion 22 is housed in the second accommodating space 28.

Referring to FIGS. 14 to 25, in some embodiments provided by the present application, the second component 20 further includes a sound-emitting portion 22, and the sound-emitting portion 22 is installed in the second accommodating space 28. The sound-emitting portion 22 is used for providing the sound outputting function of the earring-type earphone for various loudspeakers that can emit sound effects. Compared with conventional earphones, the sound-emitting portion 22 is placed at the ear canal of the user when worn, which is easy to cause damage to the hearing of the user. In this embodiment, the second component 20 is adapted to be fitted at the user's concha cavity to transmit sound effects, and does not cause damage to the hearing of the user without affecting sound production.

Referring to FIGS. 14 to 25, in some embodiments provided by the present application, the first component 10 includes a first housing 13 and a second housing 14, and the first housing 13 and the second housing 14 are connected to each other to form a first accommodating space 15.

In some embodiments provided by the present application, the first component 10 further includes a drive module, and the drive module is installed in the first accommodating space 15. Both ends of the connecting member 30 are respectively connected to the drive module of the first component 10 and the sound emitting portion 22 of the second component 20. A power supply, a control button and a circuit board are integrated on the driving module to control the sound effect transmission of the earring-type earphone.

In the present embodiment, the earring component 40 cooperates with the connecting member 30 of the functional component, and the earring component 40 can be fixed at the user's earlobe through the ear hole, thereby fixing the earring earpiece to the ear of the user.

Referring to FIGS. 1 to 25, the earring component 40 includes an earring body 42 and an earring stopper 46, and in the present embodiment, the earring body 42 is disposed on the connecting member 30. Specifically, in the present embodiment, the earring body 42 is provided to protrude and extend outward from a surface of the second housing 14 of the connecting member 30 to be inserted into the user's ear hole and fixed at the user's earlobe. The earring stopper 46 is detachably provided on the earring body 42. When the earring-type earphone is worn, the earring stopper 46 is first removed, the earring body 42 is inserted into the user's ear hole and fixed to the user's earlobe, and then the earring stopper 46 is installed on the earring body 42 to prevent the earring-type earphone from slipping from the user's ear and improve the stability of the earring-type earphone. The shape, the color, the material, etc. of the earring component 40 can be set and replaced according to the needs of the user.

In this embodiment, the earring component 40 is provided on the connecting member 30 of the functional component, so that a length of the first component 10 can be reduced, thereby reducing an overall weight of the earring earphone, so that the earring earphone can effectively reduce its pressure around the ear, reduce the pressure feeling of wearing the earring earphone for a long time on the ear, bring a more comfortable enjoyment experience to the user, and also reduce the occupied space and production cost of the earring earphone.

In this embodiment, the shape of the earring-type earphone has also changed, specifically, when the earring-type earphone is in an earphone form, in the above embodiment, the connecting member 30 is connected to a rear end of the first component 10 in a downward shape. In this embodiment, the connecting member 30 is connected to the rear end of the first component 10 and is fixedly fitted to the user's earlobe through the earring component 40. When the earring-type earphone is in an ear ornament form, in the above embodiment, the second component 20 is taken out and dropped downward as an earring, the connecting member 30 is connected to the rear end of the first component 10 and also dropped downward, the second component 20 and the connecting member 30 are both used as an earring. In the present embodiment, the connecting member 30 is connected to the rear end of the first component 10 and fixedly fitted to the user's earlobe through the earring member 40, and the second component 20 is adapted to be taken out and dropped downward as an earring.

To sum up, when the earring-type earphone is in the earphone form, the second component 20 is adapted to fit into the user's concha cavity to transmit sound effects. When the earring-type earphone is in the ear ornament form, the second component 20 is adapted to be taken out and dropped downward as an earring, so as to meet the demand of the earring-type earphone as an ornament. The earring-type earphone combines earphones with earrings, satisfies the dual demand of the user for fashion and function, and can minimize the pressure of the earring-type earphone on the user's ears and ensure the stability of the earring-type earphone.

Referring to FIGS. 1 to 25, in a third aspect, the present application provides an earring-type earphone, the earring-type earphone including:
a first component 10;
a second component 20;
a connecting member 30 connected between the first component 10 and the second component 20; and
an earring component 40 for wearing on an ear of the user;
where in an earphone form, the second component 20 is worn in the user's concha cavity to play audio; And/or, in an earring form, the earring component 40, the first component 10, and the second component 20 are connected by the connecting member 30 to be used as an earring.

The structures and functions of the first component 10, the second component 20, the connecting member 30, and the earring component 40 provided in this embodiment are completely the same as those of the first component 10, the second component 20, the connecting member 30, and the earring component 40 provided in the above-described embodiments, and will not be repeatedly described herein.

In one aspect of the present application, there is provided an earphone system, which includes earphones and a charging compartment adapted to the earphones. The earphones are the earring-type earphones. The earphones provided in the embodiments of the present application have the same structure and function as the earring-type earphones provided in the above embodiments, and will not be described in detail this time.

Basic principles of the present application have been described above with reference to specific embodiments, but it should be pointed out that the advantages, advantages, effects, etc. mentioned in the present application are merely examples and not limitations, and these advantages, advantages, effects, etc. cannot be considered to be necessary for each embodiment of the present application. In addition, the specific details disclosed above are merely for the purpose of example and convenience of understanding, and are not limiting, and the above details do not limit that the present application must be implemented with the above specific details. The functional and structural principles of the present application have been shown and described in the embodiments, and the embodiments of the present application can be modified or modified in any way without departing from the principles.

What is claimed is:

1. An earring-type earphone, comprising:
a first component, comprising a driving element communicatively connected to an external device, wherein the driving element is used to receive an audio signal from an external device;
a second component, comprising a sound-emitting portion for playing the audio signal;
a connecting member, with both ends fixedly connected to the first component and the second component respectively, wherein the driving element is electrically connected to the sound-emitting portion through the connecting member, and the driving element controls the audio signal and transmits the audio signal to the sound-emitting portion for audio playback; and
an earring component, worn on the user's ear, wherein the earring component, the first component, and the second component are connected by the connecting member to function as an ear ornament.

2. The earring-type earphone according to claim 1, wherein the earring component comprises an earring body, an ear pin, and an earring stopper; the earring body is fixedly connected to the first component and penetrated by the connecting member, the ear pin is fixedly connected to the earring component to pass through the user's ear hole, the earring stopper is detachably connected to a free end of the ear pin, and the earring body is provided with a second through-hole for the connecting member to pass through.

3. The earring-type earphone according to claim 2, wherein the first component comprises a first housing and a second housing, the first housing and the second housing are fixedly connected to form a first accommodating space for housing the driving element, and the first housing and the second housing form a fixed mounting portion connected to the earring body.

4. The earring-type earphone according to claim 3, wherein the first component further comprises a fixing frame housed within the first accommodating space and secondarily nested inside an inner side of the first housing.

5. The earring-type earphone according to claim 4, wherein the first housing is made of a non-metallic material, and/or the second housing is made of a metallic material.

6. The earring-type earphone according to claim 3, wherein the fixed mounting portion comprises a first protruding portion and a second protruding portion, the first protruding portion extends outward from an outer wall of the first housing toward a side of the earring body, the second protruding portion extends outward from an outer wall of the second housing toward a side of the earring body, the first protruding portion and the second protruding portion are oppositely arranged and form a first through-hole interconnected with the first accommodating space for the connecting member to pass through, and the first protruding portion and the second protruding portion are fixedly connected to the earring body.

7. The earring-type earphone according to claim 6, wherein the earring body is provided with a mounting groove that is mounted and matched with the first protruding portion and the second protruding portion, and the first protruding portion and the second protruding portion are fixedly installed in the mounting groove to fixedly connect the first component to the earring body.

8. The earring-type earphone according to claim 7, wherein the earring body comprises a first step portion and a second step portion, the first step portion and the second step portion protrude from a bottom of the mounting groove; and the mounting groove comprises a first cavity and a second cavity, the first cavity is enclosed by the first step portion and a groove wall of the mounting groove, the second cavity is formed between a side wall of the second step portion away from the first step portion and a groove wall of the mounting groove, and the first cavity and the second cavity are interconnected; and
wherein the first protruding portion is clamped in the first cavity, and the second protruding portion is clamped in the second cavity.

9. The earring-type earphone according to claim 8, wherein a protruding height of the first step portion protruding from the bottom of the mounting groove is lower than that of the second step portion protruding from the bottom of the mounting groove, and the protruding height of the first protruding portion is lower than that of the second protruding portion.

10. The earring-type earphone according to claim 9, wherein the earring body comprises a first side portion facing away from the second component, and the second through-hole penetrates from the bottom of the mounting groove to the first side portion; or
wherein the earring body comprises a second side portion for fixedly connecting the ear pin, and the second through-hole penetrates from the bottom of the mounting groove to the second side portion.

11. The earring-type earphone according to claim 10, wherein the second through-hole is formed at a junction of the first step portion and the second step portion, partially penetrates the first step portion, and partially penetrates the second step portion; or
wherein the second through-hole penetrates a side of the second step portion away from the first step portion.

12. The earring-type earphone according to claim 10, wherein the earring body is provided with a wire-clamping groove on a side facing away from the first component for accommodating the connecting member, the wire-clamping groove is connected to the second through-hole, and the number of wire-clamping grooves is one or two.

13. The earring-type earphone according to claim 10, wherein the earring body comprises an abutment block protruding from the second side portion to abut against the user's ear, the abutment block is located between the earring body and the ear pin, and a side of the abutment block abutting against the user's ear and a surface of the first housing close to the user's ear jointly abut against the user's earlobe.

14. An earring-type earphone, comprising:
a functional component;
a second component; and
an earring component, wherein the second component is connected to the functional component, the earring component cooperates with the functional component, and the earring component is used to pass through the user's ear hole and is fixed onto the user's earlobe.

15. The earring-type earphone according to claim 14, wherein when the earring-type earphone is in an earphone form, the second component is used to fit into the user's concha cavity to transmit sound; and when the earring-type earphone is in a decorative form, the second component is removed from the user's concha cavity and hangs downward to function as an ear ornament.

16. The earring-type earphone according to claim 15, wherein the functional component comprises a first component and a connecting member, and the first component and the second component are connected to both ends of the connecting member.

17. The earring-type earphone according to claim 16, wherein the earring component comprises an earring body and an earring stopper; the earring body is inserted into the user's ear hole, and the earring stopper is fixed to the earring body when worn and is located on both sides of the user's ear hole; and the earring body, the first component, and the second component are connected via the connecting member to function as an ear ornament.

18. The earring-type earphone according to claim 17, wherein the earring body and the first component are cooperatively arranged, and the earring stopper is detachably connected to the earring body; or
wherein the earring body and the connecting member are cooperatively arranged, and the earring stopper is detachably connected to the earring body.

19. The earring-type earphone according to claim 14, wherein the material of the earring component is at least one of copper, silver, stainless steel, precious metal, ABS material, PP material, PC material, rubber, and silicone material.

20. An earring-type earphone, comprising:
a first component;
a second component;
a connecting member, connected between the first component and the second component; and
an earring component, worn on the user's ear;
wherein when the earring-type earphone is in an earphone form, the second component is worn in the user's concha cavity to play audio; and/or, when the earring-type earphone is in an ear ornament form, the earring component, the first component, and the second component are connected via the connecting member to function as an ear ornament.
